(19) United States
(12) Patent Application Publication
(10) Pub. No.: US 2013/0323593 A1
(43) Pub. Date: Dec. 5, 2013

(54) RECHARGEABLE ENERGY STORAGE UNIT

(71) Applicants: Ines Becker, Nurnberg (DE); Thomas Purucker, Hessdorf (DE)

(72) Inventors: Ines Becker, Nurnberg (DE); Thomas Purucker, Hessdorf (DE)

(21) Appl. No.: 13/985,652

(22) PCT Filed: Feb. 15, 2012
(86) PCT No.: PCT/EP12/52591

§ 371 Date: Aug. 15, 2013

(30) Foreign Application Priority Data
Feb. 16, 2011 (DE) 10 2011 004 183.4

(51) Int. Cl. H01G 9/025; H01M 4/76

(52) U.S. Cl. CPC H01G 9/025; H01M 4/76
USPC 429/217; 361/523; 429/239; 429/232; 429/221

(57) ABSTRACT

A rechargeable energy storage unit is proposed. The rechargeable energy storage unit has a first and a second electrode. The first electrode is assigned an energy storage material in the form of metal particles made from at least one metal which can be deoxidized during charging operation of the energy storage unit and can be oxidized during discharging operation of the energy storage unit. The metal particles are incorporated into a matrix-forming carrier material.

### CROSS REFERENCE TO RELATED APPLICATIONS

This application is the US National Stage of International Application No. PCT/EP2012/052591 filed Feb. 15, 2012 and claims benefit thereof, the entire content of which is hereby incorporated herein by reference. The International Application claims priority to the German application No. 10 2011 004 183.4 filed Feb. 16, 2011, the entire contents of which is hereby incorporated herein by reference.

### FIELD OF INVENTION

The invention relates to a rechargeable energy storage unit having a first and a second electrode, wherein the first electrode is assigned an energy storage material in the form of metal particles made from at least one metal which is reducible during charging operation of the energy storage unit and is oxidizable during discharging operation of the energy storage unit.

### BACKGROUND OF INVENTION

Rechargeable energy storage units operate substantially in accordance with the principle of electrochemical cells, i.e. involving the redox-based conversion of chemical energy into electrical energy or vice versa. In the process, oxidizing agents, for example oxygen ions from atmospheric oxygen, are conventionally formed on a positively charged electrode and supplied to the negative electrode by an electrolyte which is arranged between the positive and a negative electrode and is appropriately permeable to the oxidizing agent, i.e. the oxygen ions which are formed for example.

In rechargeable energy storage units, the material to be oxidized, i.e. the reducing agent, is conventionally an indirect or direct component of the energy storage unit. The reducing agent often takes the form of metal particles acting as the energy storage material and is assigned to an electrode. The metal particles are oxidizable during discharging operation of the energy storage unit and correspondingly reducible during charging operation of the energy storage unit.

Further details regarding the mode of operation of such rechargeable energy storage units are well known.

The metal particles which are consequently required for operation of a corresponding rechargeable energy storage unit are conventionally introduced or placed, usually in the form of bulk powders, in appropriate receptacles of the first electrode in the course of production of the rechargeable energy storage unit, wherein handling of the metal particles or of the electrode filled therewith is extremely complicated with regard to further assembly of the energy storage unit with its stack-like structure. Furthermore, problems may arise during startup of the energy storage unit due to pressure pulses, whereby the pulverulent metal particles may be dislodged from the receptacles provided for them.

### SUMMARY OF INVENTION

One proposed solution to this problem involves presintering or pressing the metal particles to form, in particular rod-shaped, press-moldings. These, however, have disadvantages with regard to the porosity which is necessary for operation of the energy storage unit. In addition, they are also difficult or complicated to produce.

The problem underlying the invention is therefore that of specifying a rechargeable energy storage unit which is improved, in particular with regard to ease of manufacture.

The problem is solved according to the invention by a rechargeable energy storage unit of the above-stated kind which is distinguished in that the metal particles are incorporated into a matrix-forming carrier material.

The principle according to the invention provides incorporating the metal particles into a matrix-forming carrier material, such that it is no longer necessary to use loose bulk powders or the like when assembling the energy storage unit, i.e. in particular when associating the corresponding electrode with the metal particles. The carrier material should accordingly be considered to be a matrix with metal particles preferably well dispersed therein, wherein the filling ratio of metal particles necessary for operation of the energy storage unit amounts for example to between 60 and 80 wt. %, with upward or downward variation naturally being conceivable. The carrier material may in principle be removed, i.e. in particular burned, in the course of use of the energy storage unit, in particular due to the temperatures (>700° C.) which prevail when the energy storage unit is in operation. In this respect, care must be taken to ensure that the proportion of carrier material in the energy storage material is kept as low as possible, such that any corresponding outgassing has no harmful effects on the energy storage unit.

The matrix-forming carrier material can in particular be completely or partially cured, such that it can be hardened or converted into a solid form by physical or chemical processes, i.e. for example by evaporation of a solvent or by crosslinking, and accordingly forms a solid body, i.e. a body which can readily be handled or further processed. This furthermore means that the carrier material may be adjusted to a plurality of different geometries in a simple manner, i.e. for example by stamping, cutting or the like.

The carrier material is preferably embodied as a binder, in particular an organic or inorganic binder. Binders, such as for example those based on ceramics or plastics, constitute a matrix, in which the metal particles are embedded as a disperse system. The binder may additionally contain curable substances which, for example under the influence of heat or high-energy radiation, permit curing of the binder, such that the energy storage unit can in this manner achieve the above-stated properties of a solid.

The carrier material particularly preferably contains at least one adhesive. This embodiment of the invention therefore involves a carrier material with inherent adhesive properties and consequently an adhesive energy storage material which may be placed particularly stably on the corresponding electrode of the energy storage unit, such that it is firmly bonded or fixed thereto. A dispersion adhesive, in particular acrylate-based, may advantageously be considered as the adhesive. It goes without saying that it is in principle likewise conceivable to use other adhesives.

The carrier material may contain at least one dispersant, in particular for dispersing the metal particles. Adequate dispersion in particular of the metal particles within the matrix-forming carrier material is accordingly ensured, such that unwanted agglomeration of metal particles is prevented. Equally, the dispersant advantageously also ensures good dispersion of all the other solid particles present in the carrier material.

It is convenient for the energy storage material to be applied to an adhesive film, in particular a double-sided adhesive film. The adhesive film should be taken to be a transfer material which in particular serves for handling the energy storage material. When using a double-sided adhesive film, it is for example conceivable for said film to permit adhesion of the energy storage material to its upper side and for it to be arrangeable or fixable with its underside, together with the energy storage material placed on the upper side, in a receptacle of an electrode. This therefore gives rise to a particularly stable arrangement of the energy storage material, i.e. of the metal particles in the carrier material, within the receptacles of the electrode which are provided for this purpose. The energy storage material may be applied to the adhesive film for example by knife coating or casting, i.e. in particular film casting, it here being possible to adjust the layer thickness of the energy storage material in a particularly uniform or targeted manner.

The metal may for example be iron and/or an iron oxide compound such as for example iron(III) oxide (Fe₂O₃). The iron or iron compound may optionally contain alloy elements such as manganese (Mn), molybdenum (Mo), copper (Cu) or ceramic particles. Although compounds of other appropriately redox-active metals are conceivable in addition to iron or iron compounds, the favorable redox-active properties of iron or iron compounds particularly make them suitable for use in or as an energy storage material of a rechargeable energy storage unit. Equally, using iron or iron compounds provides cost benefits in comparison with other metals.

The previously mentioned receptacles of the first electrode are preferably of channel-like or channel-shaped construction. The energy storage material accordingly preferably takes the form of webs located in said receptacles. In addition to channel-like receptacles, receptacles of any other different shape are, of course, also conceivable, the shape of the energy storage material advantageously being modeled on the geometry of the receptacles, which, as mentioned above, is straightforwardly possible to achieve thanks to the simplicity of shaping the energy storage material.

The energy storage material has, for example, a thickness of 0.1 mm to 5 mm, preferably of 0.5 to 2 mm, particularly preferably of 1 mm. Other thicknesses of the energy storage material are, of course, also possible in exceptional cases. The energy storage material according to the invention may in principle be produced with a particularly uniform surface and in accordance with a defined layer thickness.

The present invention additionally relates to an energy storage material, in particular for use in a rechargeable energy storage system, in particular the energy storage system as described above. The energy storage material is formed from metal particles made from at least one metal which is reducible, in particular during charging operation of an energy storage unit, and is oxidizable, in particular during discharging operation of an energy storage unit, and is distinguished in that the metal particles are incorporated into a matrix-forming carrier material.

As has been described with regard to the rechargeable energy storage unit, the energy storage material may as a consequence be handled or adjusted to any desired shape in a particularly simple manner.

The carrier material is conveniently in particular embodied as an organic or inorganic binder. The binder therefore forms a matrix which accommodates the metal particles. The binder may, for instance, be based on ceramics or plastics, i.e. in particular synthetic resins.

The energy storage material may advantageously contain at least one adhesive, such as in particular a dispersion adhesive, in particular acrylate-based. As a result, the energy storage material is inherently adhesive and may be particularly readily fixed in a receptacle of an electrode of an energy storage unit. In addition to acrylate-based adhesives, other types of adhesives are of course also usable.

In a development of the invention, the carrier material may contain at least one dispersant, in particular for dispersing the metal particles. Unwanted agglomeration of metal particles or any further particles optionally present in the matrix-forming carrier material is accordingly suppressed.

It is additionally conceivable for the energy storage material to be applied onto an adhesive film, in particular a double-sided adhesive film. The film should be considered to be transfer material, and the upper side thereof preferably serves to accommodate the energy storage material and the underside serves for placement in a corresponding receptacle of an electrode, such that the energy storage material can be fixed within the receptacle by means of the film. This is in particular advantageous if the energy storage material is not itself adhesive.

The metal is advantageously iron and/or an iron oxide compound. Other, in particular redox-active metals are, of course, also conceivable in exceptional cases. It is also possible to add metallic alloy elements such as for example manganese (Mn), molybdenum (Mo), or copper (Cu) and ceramic particles.

The energy storage material advantageously has a thickness of 0.1 mm to 5 mm, preferably of 0.5 to 2 mm, particularly preferably of 1 mm. Upward or downward variations are, of course, optionally also possible.

The energy storage material according to the invention is advantageously produced by a method which is distinguished by the steps described below. Metal particles made from at least one redox-active metal are firstly provided and incorporated into a matrix-forming carrier material, i.e. a binder. The metal particles may here be dispersed in distilled water with the assistance of a dispersant prior to incorporation into the binder. Once the metal particles have been incorporated into the matrix-forming carrier material, the metal particles are dispersed in the carrier material by a mixing operation.

The energy storage material produced in this manner may be applied onto an adhesive film, for example by knife coating, film casting or screen printing, where it cures, for example by drying, such that it forms a solid body.

Furthermore, the energy storage material produced in this manner may be cut to any desired shape, stamping or cutting methods being particularly suitable for adjusting the energy storage material to corresponding geometries.

### BRIEF DESCRIPTION OF DRAWINGS

Further advantages, features and details of the invention are revealed by the exemplary embodiment described below with reference to the drawings, in which:

FIG. 1 is a schematic diagram of a rechargeable energy storage unit according to an exemplary embodiment of the invention in exploded view;

FIG. 2 is a schematic diagram of the energy storage material according to the invention in sectional view;

FIG. 3 is a schematic diagram of an electrode according to an exemplary embodiment of the invention in plan view; and

FIG. 4 is a sectional view through the anode plate according to FIG. 3 along line IV-IV.

### DETAILED DESCRIPTION OF INVENTION

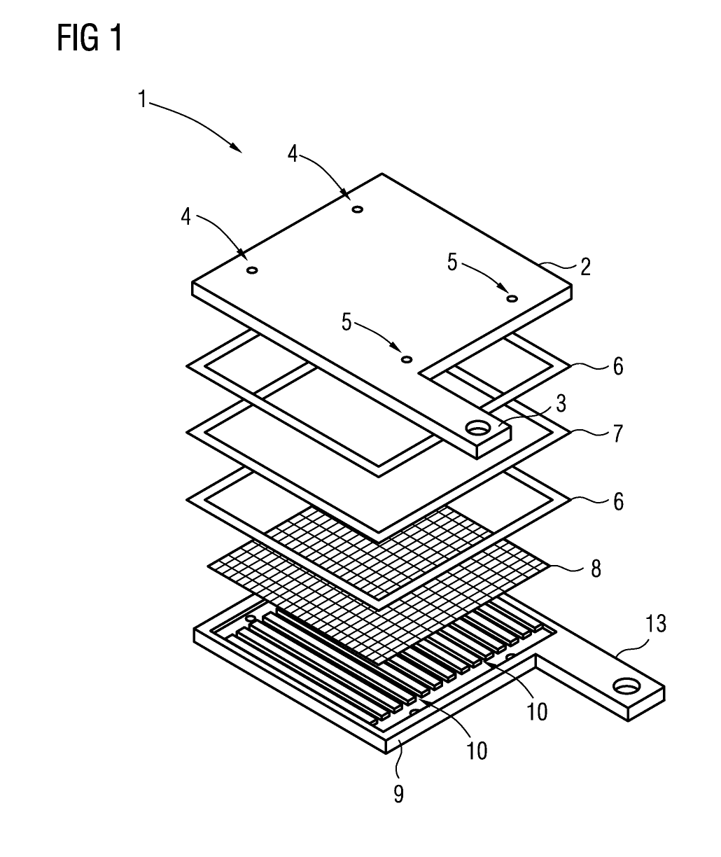

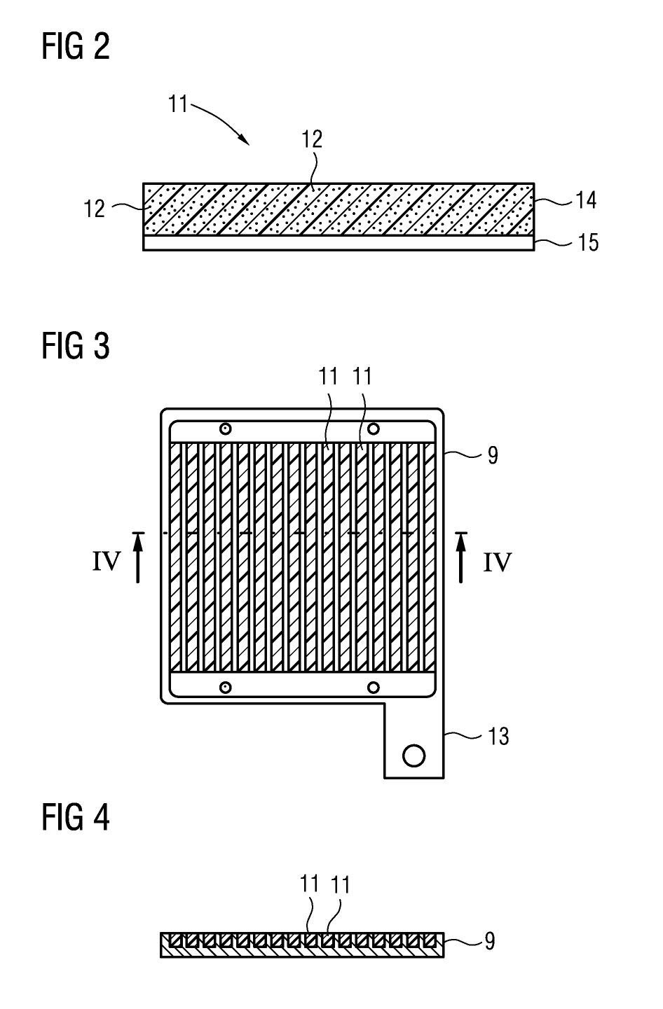

FIG. 1 shows a schematic diagram of a rechargeable energy storage unit 1 according to an exemplary embodiment of the invention in exploded view. As can be seen, the energy storage unit 1 has a stack-like structure and comprises, viewed from the top downwards, an electrode 2 in the form of a cathode base plate with an electrical connection piece 3 formed thereon for electrically contacting the electrode 2. The electrode 2 can be continuously flushed with a gas, such as for example a forming gas, via inlets 4 and outlets 5 provided for this purpose. The electrode 2 is followed by a frame part 6 which is provided for sealing purposes and may for example be made from glass. Thereunder is located a two-dimensional membrane-electrode unit 7, in particular taking the form of a solid electrolyte, which is in turn followed by a frame part 6 provided for sealing purposes. A nickel mesh 8 forms the next layer. The nickel mesh 8 serves to electrically contact the electrode 9 arranged thereunder in the form of an anode base plate which, as is explained below, is assigned in channel-like receptacles 10 provided for this purpose an energy storage material 11 (cf. FIG. 2) in the form of metal particles 12 made from at least one metal which is reducible during charging operation of the energy storage unit 1 and is oxidizable during discharging operation of the energy storage unit 1. In a similar manner to electrode 2, electrode 9 has an electrical connection piece 13.

The mode of operation of the rechargeable energy storage unit 1 according to the invention is substantially known and, in relation to discharging operation thereof, involves reducing atmospheric oxygen, which is for example continuously supplied by gas flushing, on the electrode 2, which is shown in the diagram to be negatively charged, i.e. is connected as cathode, to form oxygen ions. The resultant oxygen ions diffuse through the membrane-electrode unit 7 and the nickel mesh 8 into the electrode 9 which here acts as anode, i.e. is positively charged. The membrane-electrode unit 7 is impermeable to electrons, such that electrical short circuits of the energy storage unit 1, i.e. in particular between the electrodes 2 and 9 are prevented.

The oxygen ions which have diffused through the electrolyte and the nickel mesh 8 oxidize the energy storage material 11 or the metal particles 12 located in the receptacles 10 to form metal oxides. The metal particles 12 may here, for example, take the form of iron or iron oxide particles with a particle size of for example approx. 1 to 50 μm. The same situation applies in the case in which the energy storage material 11 does not consist of pure metal particles 12, but instead of metal oxides, such as for instance iron(III) oxide (Fe₂O₃).

The rechargeable energy storage unit 1 according to the invention may in particular be assembled particularly straightforwardly because the energy storage material 11 to be introduced into the receptacles 10 of the electrode 9 is not in the form of a loose bulk powder, but instead takes the form of a preshapeable or preshaped body. This is achieved according to the invention in that the metal particles 12 are incorporated into a matrix-forming carrier material 14, as is explained in greater detail with reference to FIG. 2. It is here possible for the carrier material 14 to burn away, i.e. to be removed, in the course of operation of the energy storage unit 1, such that only the metal particles 12 remain in the corresponding receptacles 10.

FIG. 2 shows a schematic diagram of the energy storage material 11 according to the invention in sectional view. As can be seen, the energy storage material 11 takes the form of a disperse system, i.e. the metal particles 12 are embedded in the matrix-forming carrier material 14. The matrix-forming carrier material 14 may for example be an organic binder such as for instance a synthetic resin. As a result, it is possible for the carrier material 14 together with the metal particles 12 embedded therein to be embodied as a two-dimensional body with a defined layer thickness of for example approx. 1 mm, which may furthermore be shaped into any desired number of geometries and in particular may be adjusted, for example by stamping and cutting processes, exactly to the geometry of the receptacles 10 of the electrode 9 and may furthermore be introduced with an exact fit into said receptacles (cf. FIGS. 3 and 4).

The carrier material 14 advantageously additionally contains a dispersant (not shown) which ensures good dispersion of the metal particles 12 in the binder matrix formed by the carrier material 14.

According to FIG. 2, the energy storage material 11 is applied onto a double-sided adhesive film 15, wherein the adhesive upper side of the film 15 ensures secure adhesion of the energy storage material 11 to the film 15 and the underside ensures secure adhesion of the film 15 together with the energy storage material 11 applied to the upper side thereof in one of the receptacles 10 of the electrode 9. The energy storage material 11 prepared in this manner and applied onto the film 15 can therefore be securely, i.e. substantially captively, fixed in the receptacles 10 of the electrode 9, such that the risk of slippage or removal from the receptacles 10 as a result of any movement which occurs during assembly of the energy storage unit 1 is eliminated. The energy storage material 11 is preferably applied onto the film 15 by knife coating or film casting, since it is possible in this manner to establish a uniform layer thickness of the energy storage material 11.

It is likewise conceivable for the carrier material 14 to contain an adhesive (not shown), such that the energy storage material 11 is inherently adhesive and can also be fixed adhesively in the receptacles 10 of the electrode 9 without a film 15. The adhesive used is preferably a dispersion adhesive, in particular acrylate-based. It goes without saying that, also in the case of a carrier material 14 containing an adhesive, the energy storage material 11 can also be applied onto an adhesive film 15.

With reference to FIGS. 3 and 4, it can be seen that the energy storage material 11 can be introduced with an exact fit into the channel-like receptacles 10 of the plate-like electrode 9. The energy storage material 11 is modeled on the shape of the channel-like receptacles 10 and takes the form of individual web-like or strip-like bodies. The embodiments according to FIGS. 3 and 4 relate to an energy storage material 11 with adhesives contained therein, i.e. the energy storage material 11 is inherently adhesive and can therefore be fixed with a proper fit in the receptacles 10. Any movement of the electrode 9 which may possibly occur during assembly of the energy storage unit 1 consequently does not result in slippage or removal of the energy storage material 11 from the receptacles 10.

1.-18. (canceled)

19. A rechargeable energy storage unit, comprising:
a first electrode; and
a second electrode,
wherein the first electrode is assigned an energy storage material comprising metal particles made from at least one metal which is reducible during charging operation of the energy storage unit and is oxidizable during discharging operation of the energy storage unit,
wherein the metal particles are incorporated into a matrix-forming carrier material, and
wherein the energy storage material is introduced as a solid, preshaped body into a receptacle of the first electrode.

20. The rechargeable energy storage unit as claimed in claim 19, wherein the carrier material comprises a binder, an organic binder or an inorganic binder.

21. The rechargeable energy storage unit as claimed in claim 19, wherein the carrier material comprises at least one adhesive.

22. The rechargeable energy storage unit as claimed in claim 21, wherein the adhesive is a dispersion adhesive or an acrylate-based dispersion adhesive.

23. The rechargeable energy storage unit as claimed in claim 19, wherein the carrier material comprises at least one dispersant for dispersing the metal particles.

24. The rechargeable energy storage unit as claimed in claim 19, wherein the energy storage material is applied onto an adhesive film or a double-sided adhesive film.

25. The rechargeable energy storage unit as claimed in claim 19, wherein the metal is iron and/or an iron oxide compound.

26. The rechargeable energy storage unit as claimed in claim 19, wherein the first electrode comprises at least one channel-like receptacle for accommodating the energy storage material.

27. The rechargeable energy storage unit as claimed in claim 19, wherein the energy storage material takes a form of webs.

28. The rechargeable energy storage unit as claimed in claim 19, wherein the energy storage material has a thickness of 0.1 mm to 5 mm, or a thickness of 0.5 to 2 mm, or a thickness of 1 mm.

29. An energy storage material for use in a rechargeable energy storage unit, comprising:
metal particles made from at least one metal which is reducible during charging operation of the energy storage unit and is oxidizable during discharging operation of the energy storage unit,
wherein the metal particles are incorporated into a matrix-forming carrier material,
wherein the energy storage material takes a form of a solid, preshaped or preshapeable body prior to introduction into a receptacle of an electrode of the energy storage unit, and
wherein the energy storage unit is claimed as in claim 19.

30. The energy storage material as claimed in claim 29, wherein the carrier material comprises a binder, an organic binder or an inorganic binder.

31. The energy storage material as claimed in claim 29, wherein the carrier material comprises at least one adhesive.

32. The energy storage material as claimed in claim 31, wherein the adhesive is a dispersion adhesive or an acrylate-based dispersion adhesive.

33. The energy storage material as claimed in claim 29, wherein the carrier material comprises at least one dispersant for dispersing the metal particles.

34. The energy storage material as claimed in claim 29, wherein the energy storage material is applied onto an adhesive film or a double-sided adhesive film.

35. The energy storage material as claimed in claim 29, wherein the metal is iron and/or an iron oxide compound.

36. The energy storage material as claimed in claim 29, wherein the energy storage material has a thickness of 0.1 mm to 5 mm, or a thickness of 0.5 to 2 mm, or a thickness of 1 mm.
